(19) United States
(12) Patent Application Publication
(10) Pub. No.: US 2019/0156193 A1
(43) Pub. Date: May 23, 2019

(54) SYSTEM AND METHOD FOR PROCESSING COMPLEX DATASETS BY CLASSIFYING ABSTRACT REPRESENTATIONS THEREOF

(71) Applicant: Colossio, Inc., Chicago, IL (US)

(72) Inventor: Joseph A. Jaroch, Chicago, IL (US)

(21) Appl. No.: 15/817,466

(22) Filed: Nov. 20, 2017

(51) Int. Cl. G06N 3/08; G06F 17/30; G06K 9/62

(52) U.S. Cl. CPC G06N 3/08; G06F 17/30283; H04L 67/42; G06K 9/6269; G06K 9/6215; G06F 17/30705

(57) ABSTRACT

In the present disclosure, a system for analyzing complex datasets includes one or more servers, one or more machine learning algorithms, one or more client devices having one or more displays, and a network connecting the one or more servers and the one or more client devices. A complex dataset is stored on the one or more servers and is parsed into one or more chunks, which are abstracted as a plurality of abstract representations to form a plurality of graphical matrices. Still further, the one or more servers transmit, over the network to the one or more client devices, graphical matrices developed from the complex dataset for display to a human observer. The system includes the human observer comparing the first and second graphical matrices as well as classifying the graphical matrices, and said classification providing the one or more machine learning algorithms with information about the complex dataset.

### CROSS-REFERENCE TO RELATED APPLICATIONS

Not applicable

### TECHNICAL FIELD

The present disclosure generally relates to machine learning, and more specifically relates to a system and method for training one or more machine learning algorithms with feedback produced by the innate pattern recognition abilities of human observers.

### BACKGROUND

Many types and/or sources of complex data pose challenges for conventional natural language processing and artificial intelligence algorithms and systems. Among such complex sets of data are unstructured social media posts, medical treatment records, and/or other relatively unstructured forms of data. A conventional approach to negotiation and analysis of such complex datasets involves attempting to normalize data thereby returning structure to social media messages, medical treatment records, or any particular underlying data from which the complex dataset is composed. However, one consequence of normalizing the underlying data is that some aspects of intrinsic meaning are lost. Losing such intrinsic meaning, before analysis of the complex data takes place, results in deviation from the underlying data to an extent that may lead to misinterpretation.

The system contemplated throughout this disclosure embraces the ambiguity of complex, unstructured datasets by parsing the data in the original state thereof, instead of attempting to normalize said data. In the case of text, such an approach may avoid conventional word stemming. Still further, the approach contemplated by this disclosure may retain contractions, slang, colloquialisms, and netspeak, among other unique variances within the dataset. Further, such a system may represent an advantage over the prior art by avoiding well-known sources of error that often occur during parsing of sentences with missing components, e.g. no subject, no verb, etc. Accordingly, the system and method described hereinbelow improves how a computer or computing environment handles complex data and how a computer or computing environment derives meaning from said complex data. This system and method improves the functioning of a machine learning algorithm by improving how the algorithm is trained.

The description provided in the background section should not be assumed to be prior art merely because it is mentioned in or associated with the background section. The background section may include information that describes one or more aspects of the subject technology.

### SUMMARY

According to certain aspects of the present disclosure, a system for analyzing complex datasets includes one or more servers, one or more machine learning algorithms, one or more client devices having one or more displays, and a network connecting the one or more servers and the one or more client devices. Further, according to this aspect, a complex dataset is stored on the one or more servers and is processed thereby. Also according to this aspect, the complex dataset is parsed into one or more chunks and the one or more chunks are abstracted as a plurality of abstract representations, which form a plurality of graphical matrices. Still further contemplated by this aspect, the one or more servers transmit, over the network to the one or more client devices, graphical matrices developed from the complex dataset for display to a human observer. In addition, the system includes the human observer comparing the first and second graphical matrices as well as classifying the graphical matrices, and said classification providing the one or more machine learning algorithms with information about the complex dataset.

According to another aspect of the present disclosure, a method of analyzing complex datasets includes parsing a complex dataset into one or more chunks, interpreting each chunk as one or more respective abstract representations, and presenting the one or more abstract representations to one or more human observers as one or more visual representations. Also according to this aspect, the one or more human observers are presented with first and second visual representations of the one or more abstract representations, and the one or more human observers compares the first and second visual representations to produce one or more respective classifications. Further, in accordance with this aspect, the method includes receiving the one or more classifications of the respective one or more visual representations, providing the one or more classifications to a machine learning algorithm, and analyzing the complex dataset in view of the one or more classifications.

According to yet another aspect of the present disclosure, a system for training neural networks includes a server connected to a network, a plurality of client devices connected to the network, at least one neural network algorithm executed by a processor and memory of the server, and a complex dataset available to the server for analysis. Further in accordance with this aspect, the system separates the complex dataset into chunks and the chunks of the complex dataset are interpreted as abstract representations by an abstract representation function. Also, the system includes displaying the abstract representations to human observers by the plurality of client devices wherein the human observers recognize patterns among the abstract representations, and a result of the pattern recognition of the human observers is applied to the training of the at least one neural network algorithm.

Other aspects and advantages of the present disclosure will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A illustrates an example system for providing abstract representations of complex datasets to human observer(s) and recording feedback therefrom;

FIG. 1B depicts example abstract representations developed by the system for presentation to the one or more human observer(s);

FIG. 2 is a flowchart depicting an example module performing an example process of the system of FIG. 1 according to certain aspects of the disclosure;

FIG. 3 is a flowchart depicting another example module performing another example process of the system of FIG. 1 according to certain aspects of the disclosure;

FIG. 4 is a flowchart depicting another example module performing another example process of the system of FIG. 1, in conjunction with the module and process of FIG. 3, according to certain aspects of the disclosure;

FIG. 5 is a flowchart depicting another example module performing another example process of the system of FIG. 1 according to certain aspects of the disclosure; and

FIG. 6 is a flowchart depicting another example module performing another example process of the system of FIG. 1 according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Still further, modules and processes depicted may be combined, in whole or in part, and/or divided, into one or more different parts, as applicable to fit particular implementations without departing from the scope of the present disclosure. Accordingly, the drawings and description are to be regarded as illustrative in nature and not restrictive.

General Overview

The human brain is exceptionally skilled at identifying patterns in both complex and simple data. For example, humans are able to identify graphic patterns (e.g., identifying animals in clouds, constellations among stars of the night sky, etc.), guess a next number based on a previously presented sequence of numbers, spot a moving threat from great distances, and identify faces in a crowd of people. Conventional computing devices are poorly suited to the type of creative pattern matching innate to the human brain. However, computing devices may perform pattern matching tasks such as, for example, facial recognition and numerical analysis, with the aid of algorithms constructed specifically for the purpose of the particular pattern recognition task.

According to the previous state of the art, natural language processing and artificial intelligence algorithms often require extensive training to operate accurately on human speech or text. Even then, natural language processing suffers from the disadvantage that pattern recognition is difficult for computers to perform. Likewise, image processing and audio processing algorithms may be adequate for matching images or identifying similar audio samples, respectively, but such algorithms again are relatively unable to find overarching patterns and/or subtle patterns present in this data. The system and method of the present disclosure provides deeper insight into large data sets, by using one or more human observers to identify patterns within visual presentations of the data when abstractly represented, such as by shapes and colors. This solution is more efficient and more computationally feasible as compared algorithms already known in the art.

The disclosed system addresses a technical problem tied to computer technology and arising in the realm of unstructured computer-generated content, such as social media posts, medical treatment records, and/or bank transactions, and the training of neural networks to recognize such patterns. The disclosed system solves this technical problem by embracing the ambiguity of unstructured data and parsing said data in its natural state, rather than attempting to normalize it. This involves avoiding conventional word stemming, retaining contractions in place, retaining netspeak as-is, and avoiding pitfalls that may occur when trying to parse sentences with missing components (e.g., no subject, no verb, etc.).

The disclosed system provides a solution necessarily rooted in computer technology, as it requires processing and transformation of data into abstract visual representations, display of the abstract visual representations to human observers, recordation of the feedback from the human observers, and the training of neural networks with the feedback of the human observers. The disclosed system 100 improves the way in which information across plural networks, servers, and databases is analyzed, interpreted, and presented for use by any organization/brand/entity interested in identifying patterns in sentiment or outcome from amongst complex datasets.

The system described herein may be deployed on a very powerful server, in particular one with parallel processing capabilities and ample storage space. One or more graphics cards present in a system server(s) may be used as optimization tools for processing additional operations in parallel. Also, the generated workload may be optimally distributed across multiple different physical computers, i.e., a network of computers/servers. The storage and hosting of the data produced by the system may be held locally or distributed across one or more remote datacenters, depending on storage requirements. Further, this system may employ any number of user devices in order to present abstract representations to users and received feedback concerning the presented abstract representations. All of the above-noted components operate together within a networked computing environment to improve how computers analyze and interpret historical hard-to-manage datasets.

Example System Implementation

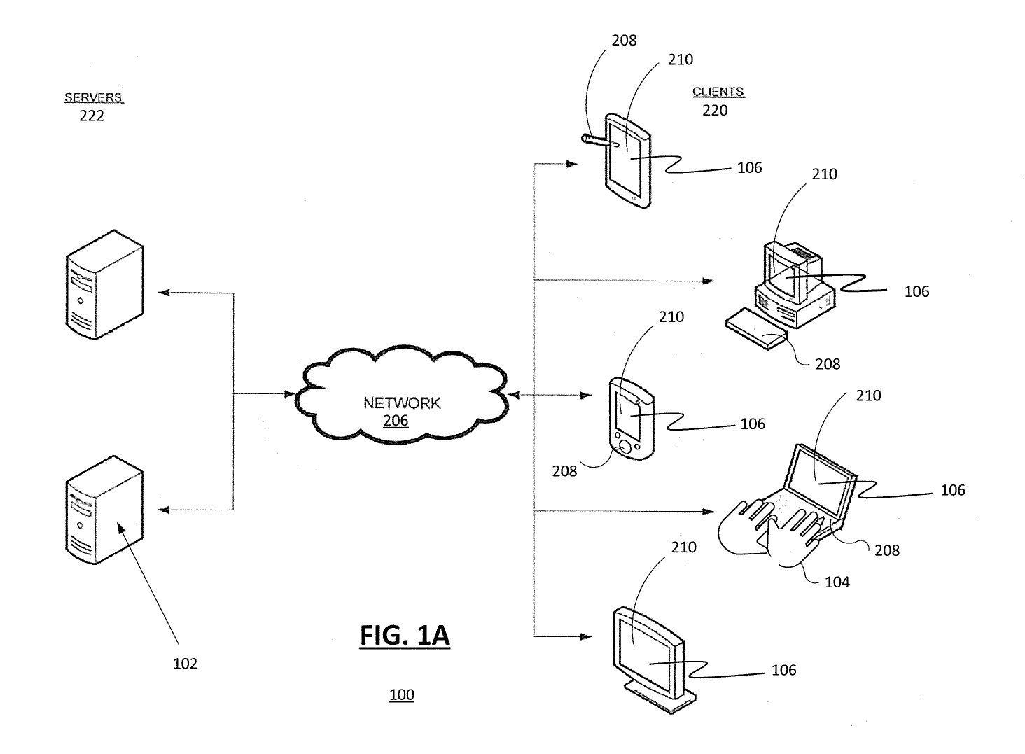

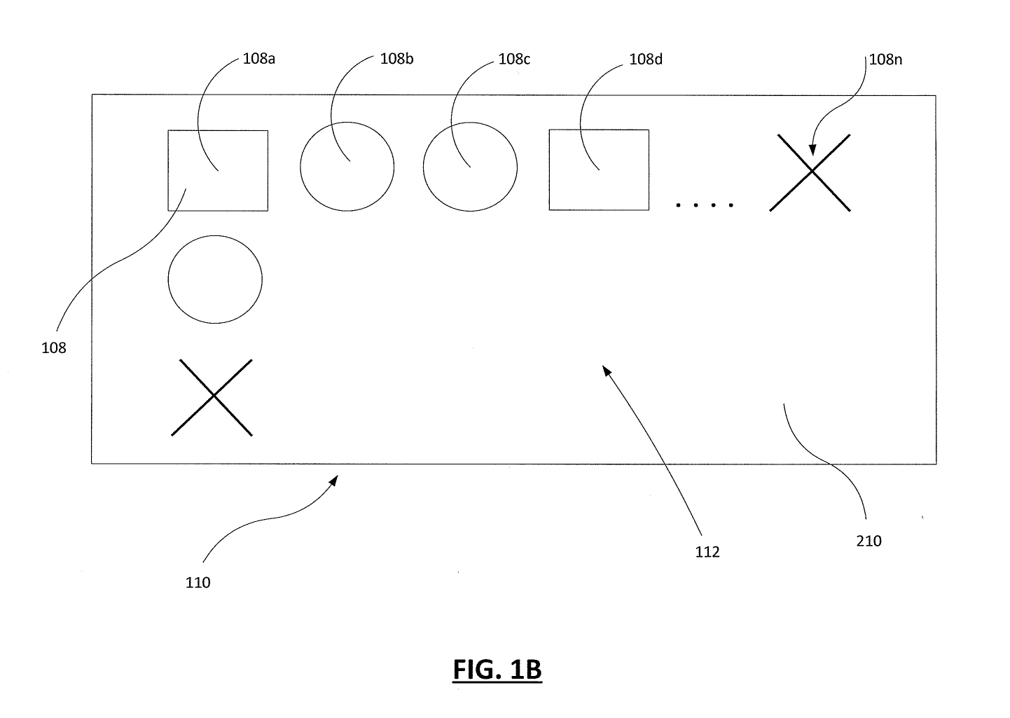

In one embodiment illustrated by FIG. 1A, a system 100 disclosed herein identifies a sentiment associated with portion(s) of one or more particular dataset(s) 102 by leveraging the intuitive pattern matching abilities of one or more human observers 104. In other words, the system 100 uses aspects of human pattern recognition that come easily and naturally to the humans 104 and applies same to the benefit of one or more computing devices/servers 222 of the system 100. Generally, the system 100 creates abstract representations 108 (see FIG. 1B) of the complex datasets 102 for observation by the inexperienced human observer(s) 104. Then the human observer(s) 104 perform pattern recognition within a predictable and predetermined framework provided by the system 100 and facilitated by the development of the abstraction representations 108.

The outcome of the pattern recognition of the human observer(s) 104, or classification 114, may be used to train machine learning algorithms 116 to spot patterns. Advantageously, the system 100 may operate without making assumptions about the complex datasets 102. Furthermore, because the complex datasets 102 are abstractly represented, rather than being presented with the full complexity thereof intact, the human observer(s) 104 do not need advanced knowledge of data analysis or training in the intricacies of same. Instead, the human observer(s) 104 are able to use the innate pattern matching operation of the human brain to train complex machine learning models 116.

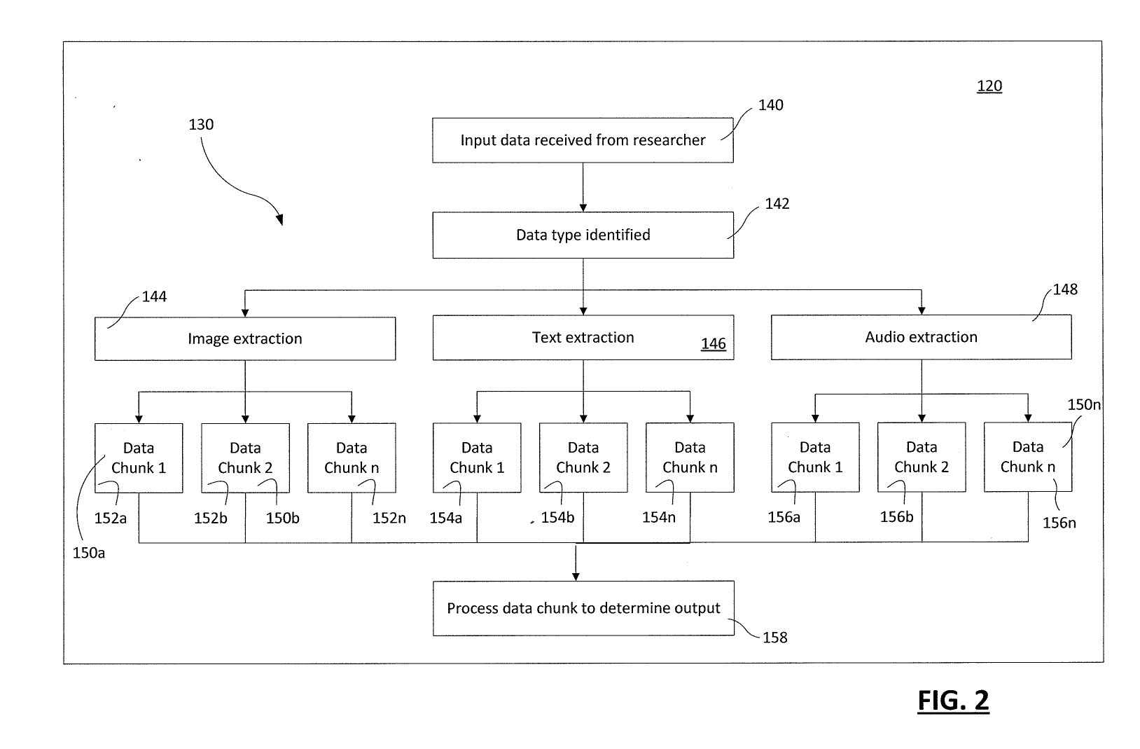

Architecturally, the representative technology can be deployed anywhere. For example, it may be preferable for the server 222 to have a significant amount of computing power because processing the dataset 102 and producing the abstractions 108 thereof may be demanding on computation resources, e.g., processor throughput, memory access, etc. Example embodiments of the disclosed system 100 are described herein with reference to FIGS. 2-6 which illustrate modules 120, 122, 124, 126, 128 of the system 100, which, taken together, illustrate the system 100 as well as the processes 130, 132, 134, 136, 138 performed by the system 100. While the example processes 130, 132, 134, 136, 138 of FIGS. 2-6 are described with reference to FIG. 1A, it should be noted that steps of the processes 130, 132, 134, 136, 138 may be performed by other systems including systems having more or fewer parts relative the system 100 of FIG. 1A.

Referring still to FIG. 1A, a schematic illustrates specific example computing structures for operation of the modules and processes detailed herein. In certain aspects, the system 100 may be implemented using hardware or a combination of software and hardware, either in a dedicated server, integrated into another entity, or distributed across multiple entities. The system 100 may include two primary architectural/hardware components including the at least one client device 220 and the at least one server 222. The client device(s) 220 may be, for example, desktop computers, mobile computers, tablet computers (e.g., including e-book readers), mobile devices (e.g., a smartphone or personal digital assistant), set top boxes (e.g., for a television), video game consoles, or any other devices having appropriate processor, memory, and communications capabilities for selection of a content item and/or analyzing a body of data. The system 100 queries resources on the client device(s) 220 or over the network 206 from one of the server(s) 222 to obtain and display additional content and/or information related to the abstract representation(s) 108.

The client device(s) 220 may connect with the system 100 by way of an endpoint 106, such as a smartphone application or a website. The server(s) 222 may further comprise one or more associated computing devices including a backend application server (i.e., webserver) and/or a database server. The server 222 stores and processes the complex dataset 102 as well as communicates requests for classification to the endpoint 106 and receives classifications 114 therefrom. One or more of the servers 222 are configured to host various databases that include actions, documents, graphics, files, and any other suitable sources of data. The databases may include, for each source in the database, information on the relevance or weight of the source of the data. The application database on the servers 222 may be queried by client device(s) 220 over the network 206. For purposes of load balancing, multiple servers 222 may host the application server and/or database either individually or in portions.

The server(s) 222 may be any device having an appropriate processor, memory, and communications capability for hosting content and information. The network 206 may include, for example, any one or more of a personal area network (PAN), a local area network (LAN), a campus area network (CAN), a metropolitan area network (MAN), a wide area network (WAN), a broadband network (BBN), the Internet, and the like. Further, the network 206 may include, but is not limited to, any one or more of the following network topologies, including a bus network, a star network, a ring network, a mesh network, a star-bus network, tree or hierarchical network, and the like.

The endpoint 106 operates in part as a display tool for interaction with the one or more human observers 104. As a display and communications tool, a smartphone application receives the data developed by the backend server and presents it to the human observer(s) 104. In an example embodiment, information from the backend server is represented graphically through a smartphone application so that the one or more relatively inexperienced human observer(s) 104 may perform pattern recognition. In order to perform the pattern recognition, the one or more human observers 104 do not need to interpret complex floating point numbers or sift through large amounts of raw data. Instead, as detailed hereafter, the data for each task directed to the one or more human observers 104 is abstracted by a processor associated with the webserver or database server before being sent to a display tool/output device 210 at the endpoint 106. This system flow ensures that the endpoint display tool may operate while occupying a minimal quantity of bandwidth.

Referring now to the module 120 of FIG. 2, an example embodiment of the extraction process 130 for producing the abstract representation(s) 108 of the one or more complex dataset(s) 102 is shown. The extraction module 120 of FIG. 2 performs the extraction process 130 wherein the one or more complex dataset(s) 102 are input to the module 120 from a suitable source, such as a researcher, a webpage, a database, a social media platform, and/or any other source of complex data, at step 140. A type of data contained within the complex dataset 102 is identified in step 142a of the process 130. The dataset 102 may be identified as image data, text data, or audio data. This data type identification step 142a directs transmission of the dataset 102 to an appropriate subroutine 144, 146, 148 of the extraction process 130. The extraction function performed on the dataset 102 may be matched to the type of data being abstracted thereby. More specifically, the first subroutine 144 performs the extraction function on image data, while the second and third subroutines 146, 148 perform the extraction function on text and audio, respectively.

The dataset 102 is split into individual chunks 150a, 150b, . . . 150n wherein the chunks 150a-n comprise one or more portions/strings for processing by each subroutine 144, 146, and 148. Alternatively, the subroutines 144, 146, 148 may receive the entirety of the complex dataset 102 and output the abstract representation(s) 108 by chunks 150a-n. For example, each of the chunks 150a-n may be represented by one of the individual abstract representation(s) 108. In further example embodiments, the one or more abstract data representations 108 may each represent one or more chunks 150a-n.

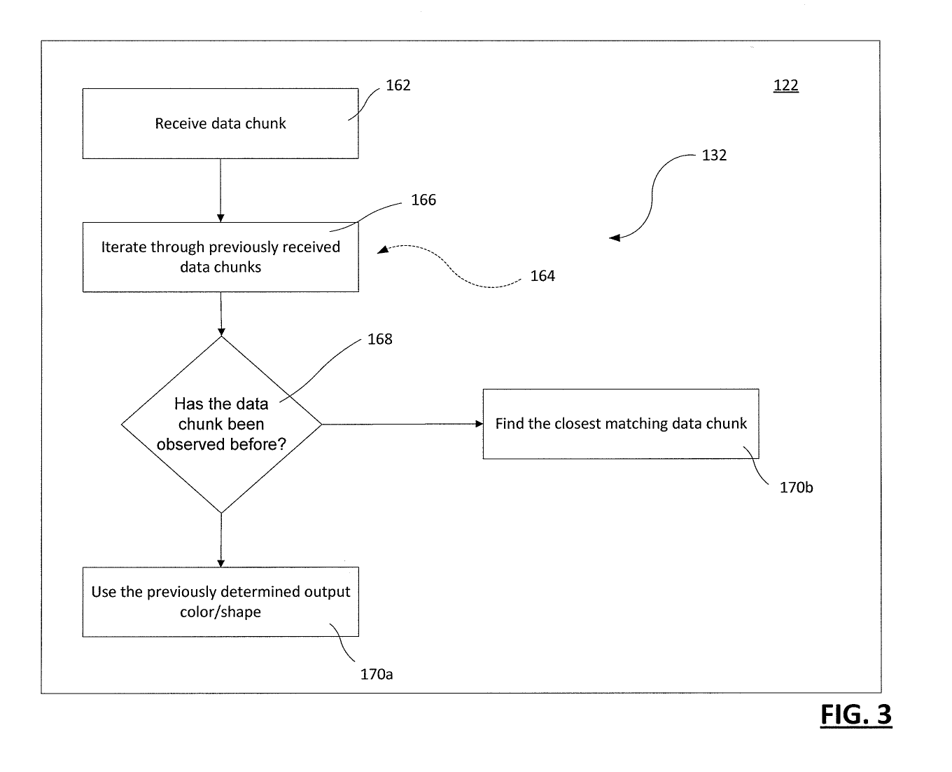

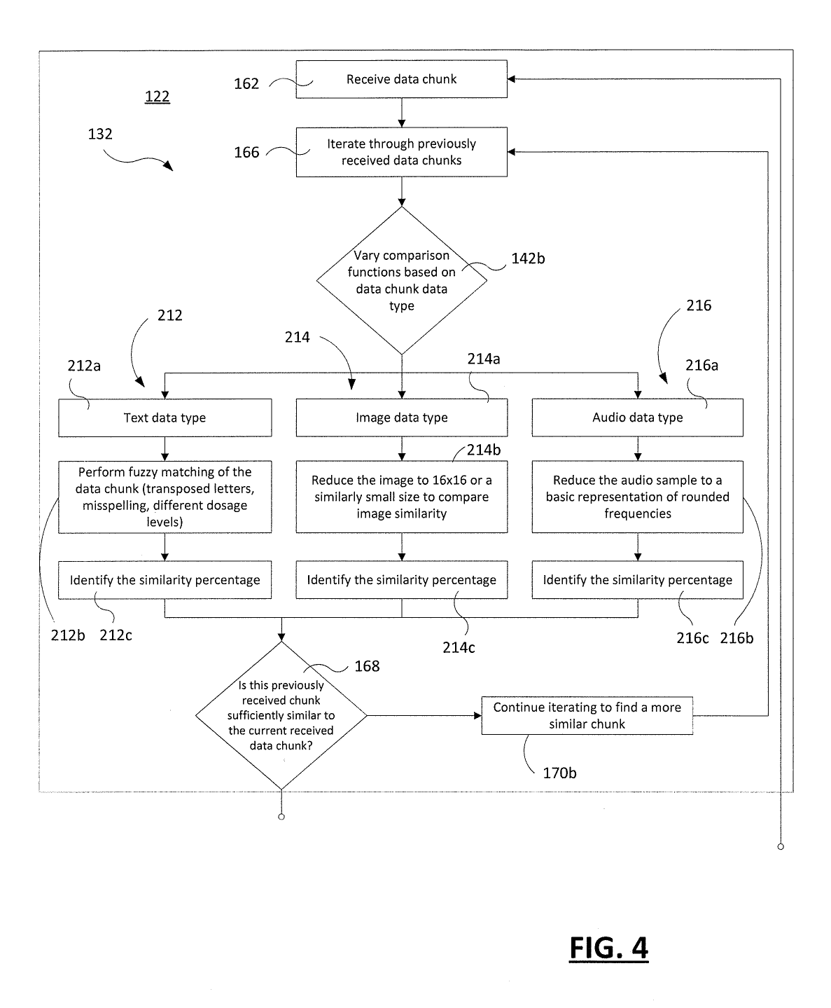

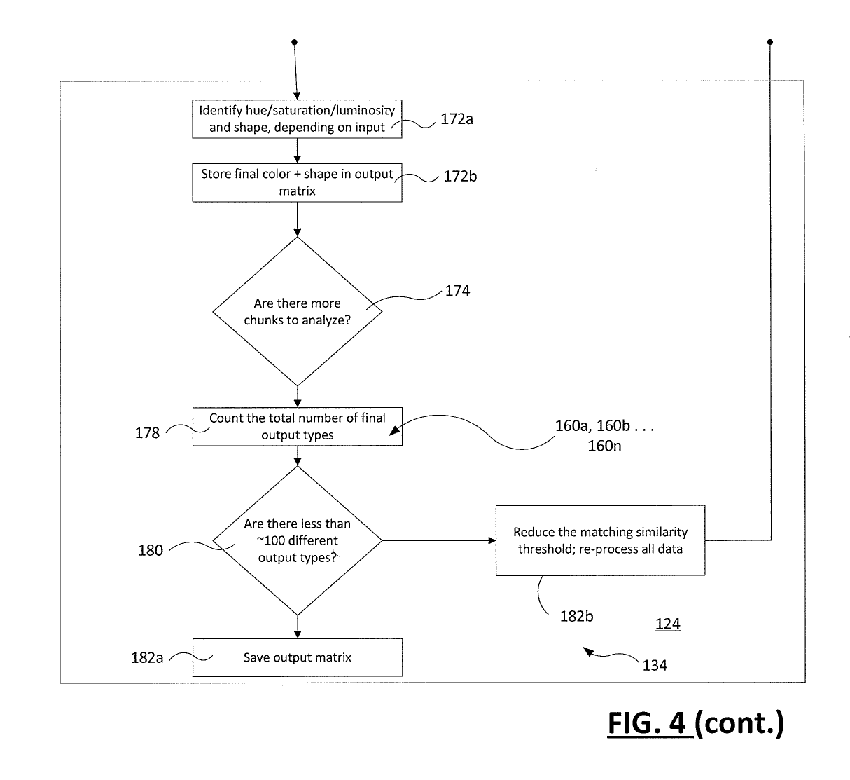

Example embodiments wherein the dataset 102 may comprise more than one type of data are also contemplated hereby. Therefore, more than one of the subroutines 144, 146, 148 may run and the data chunks 150a-n may instead be one or more sets of type-dependent chunks 152a, 152b, . . . 150n; 154a, 154b, . . . 154n; 156a, 156b, . . . 156n. Still further, the size of the chunks 150a-n may depend on one or more of the particular application of the system 100, a specific extraction subroutine, and/or the amount and type of outputs desired (See FIGS. 3 and 4). For example, an entire novel may be supplied as any one of the following: the dataset 102, one of the chunks 150a-n, or one of the portions/strings of one of the chunks 150a-n. For the purpose of examples described herein, the dataset 102, and therefore the chunks 150a-n comprising same, are of a single type. Following extraction, at step 158 the one or more chunks 150a-n are further processed to determine an abstraction type 108a, 108b, . . . 108n of the abstract representation 108 (see FIG. 1B) developed by the system 100; such process being further detailed herein with respect to FIG. 4.

FIG. 2 depicts the iterative chunk comparison module 122. The iterative chunk comparison module 122 carries out the chunk comparing process 132 wherein one or more chunks 150a-n are received at step 162. The received chunks 150a-n together form a repository 164 of the previously received chunks. The repository 164 of received chunks 150a-n represents the data abstractions 108 that have already been extracted from the complex dataset 102. Depending on system constraints, the repository 164 of chunks 150a-n may be populated over time, i.e., the repository 164 receives a first chunk during processing and grows in size as chunks 150a-n continue to be processed and compared against chunks held within the repository 164. In other example embodiments, the repository 164 may be populated all at once, simultaneous with the beginning of operation for module 122. Memory, processor speed, and data transmission speed specifications may vary as appropriate for the implementation of the chunk comparing process 132. As the one or more chunks 150a-n are received, each received chunk is compared with the one or more chunks in the repository 164 at iterative step 166. If the received chunk 150a matches one or more chunks of the repository 164, said chunk 150a is counted as having been previously observed at chunk matching step 168. One or more counters may numerically track the occurrence of matching chunks at step 168. The result of comparison step 168, leads process 132 to either step 170a or 170b. If comparison step 168 results in a match, then step 170a will assign the received chunk 150a the same previously determined abstract representation 108 of the matching chunk. However, if comparison step 168 determines that no match exists, then step 170b searches for the chunk closest to a match. The closest matching chunk may then be used in module 124 as an input to the optimization process 134, described further with reference to FIG. 4.

The abstract representation 108 of the one or more chunks 150a-n may be in the form of color. The abstract representation 108 may be a graphical representation of aspects of data found in the one or more chunks 150a-n. For example, hue may represent the entropy (the unpredictability of the information), saturation may represent the average/mean value of the content within a data chunk, and luminosity may represent the median value of a data chunk. The values used for hue, saturation, and luminosity may be scored on a continuous basis, modulus 255, so that such values may be relatively easily reflected within the standard RGB (Red-Green-Blue) color palate.

According to further example embodiments, the output/visual representation 110 may instead be developed within shapes, graphics, lines, and/or any other repeatable image suitable for representing the qualities of the dataset 102 visually and abstractly to the human observer(s) 104. Values for the abstract representation 108 are, in part, determined by a comparison between each data chunk 150a-n to be represented and all other data chunks 150 forming the repository 164. For example, with a text dataset containing medical treatment information, all entries indicating that ibuprofen was administered have the same color and shape. If a particular entry, i.e. data chunk, contains the text “ibuprofen 500 mg” and another contains the text “ibuprofen 250 mg”, such text entries, i.e., data chunks, should be identified as similar by a fuzzy comparison algorithm of subroutine 144.

The degree to which similarity is relevant for developing the abstract representations 108a-n may depend on the particular application of the system 100 and the complex dataset 102. Returning to the example of medical treatment information mentioned hereinabove, if the example dataset includes a large set of medical treatments, which further comprise a wide range of different medications, the specific milligram dosage of an example medication, such as ibuprofen, may not be particularly meaningful. Thus, representations of dosage may be eliminated or handled cumulatively by the fuzzy comparison algorithm of subroutine 144. However, if another example medical treatment dataset contains only relatively few different medications and the dose of each medication varies considerably, the degree of relevance for the entire text string describing the medication and dosage is increased. One may intuitively recognize that in the second example dataset, the type of medication and dosage may carry more mean; therefore, the abstract representation 108 of these details should correspondingly increase. For the first example dataset, the abstract representation 108 for example data chunk portions/strings “ibuprofen 500 mg” and “ibuprofen 250 mg” may be a red circle in both instances. Likewise, for the second example dataset, the portions/strings “ibuprofen 500 mg” and “ibuprofen 250 mg” may both be represented by a circle. However, in this second example, the “ibuprofen 500 mg” circles may be red whereas the “ibuprofen 250 mg” circles may be orange so as to differentiate the two strings within the abstract representation 108 and accordingly highlight the increased relevancy of the medication and dosage information.

Referring again to FIG. 4, the module 122 and the process 132 are shown with further detail concerning performance of optimization subroutines 212, 214, 216 within the chunk comparing process 132. The optimization details of process 132, as shown in FIG. 4, in part, develop granularity of the abstract representations 108 illustrated by the use-cases, i.e., example datasets detailed hereinabove. The process 132 affects the resulting abstract representations 108 by determining, at step 142b, the appropriate optimization subroutine 212, 214, 216 to differentiate chunks with data-type specificity. Specifically, if the complex dataset 102 from which the chunk(s) 150a-n are drawn is text data, image data, or audio data, then different algorithms may be best suited for comparing the chunks 150a-n passing through process 132. The data type identifying step 142b directs text data through step 212a to step 212b whereby a fuzzy matching algorithm compares the chunks 150a-n for similarity. Alternatively, the data-typing step 142b, directs image data through step 214a to step 214b whereby the image data may be compressed for easier comparison/similarity testing. In the further alternative, step 142b funnels audio data through step 216a to a comparison step 216b that derives rounded frequencies representing the basic qualities of the audio for similarity testing amongst same. Following application of the comparison algorithms at steps 212b, 214b, 216b, the similarity percentage of the compared chunks 150a-n is identified at respective steps 212c, 214c, 216c. These similarity identifying steps 212c, 214c, 216c, pass the similarity percentage through to the chunk matching step 168 for evaluation against predetermined system goals/parameters.

The module 134, during steps 172a, 172b of an initial abstraction procedure, develops a particular number of unique abstract representations 108a, 108b, . . . 108n. Referring back to FIG. 1B, the complex dataset 102 may result in the following abstract representations 108: red square, red circle, blue circle, and red square, 108a, 108b, 108c, 108a, respectively. In this example visual representation 110, four abstract representations 108a-d have been produced, but only three different types of abstract representations 108a-c have been produced. It may be advantageous to limit the number of different types of abstract representations 108 produced when the dataset 102 is graphically displayed as the visual representation 110. It is possible that outputting too many different types of abstract representations 108 may result in the human observer(s) 104 perceiving such increased granularity as noise, thereby decreasing the ease and accuracy with which the human observer(s) 104 are able to identify patterns within and similarities between the visual representations 110.

In step 174, module 124 determines whether analysis of additional chunks 150a-n remains uncompleted. If more chunks remain to be analyzed and abstracted, the system 100 waits for such processing to reach completion. Following the completion of the abstraction steps 172a, 172b and checking step 174, the number of distinct types of abstract representations 108 present in the visual representation 110 is totaled at step 178. Then, at abstraction constraint step 180, the total number of abstraction types 108a-n present is compared with a predetermined number of acceptable output types. In the example embodiment of FIG. 4, step 180 compares the current total number of abstract representation types 108a-n with a desired number of one-hundred abstraction types. Therefore, if the step 180 indicates that greater than the desired one hundred output types have currently been produced for the visual representation 110 (i.e., output matrix 112), then the system 100 moves to step 182b. At step 182b, the similarity threshold used by the subroutines 212, 214, 216 during another iteration of the chunk comparing process 132 is reduced. Following the reduction of the similarity threshold, a next iteration of the optimization process 132 should result in a greater quantity of similar outputs (to process 134), thereby reducing a threshold of difference between compared data chunks 150a-n by a particular factor, such as by 10% or thereabout. The factor by which the threshold of difference is reduced may be selectable and/or customizable, as applicable. Likewise, the target number of unique abstract representations 108a-n may be selectable and/or customizable, as suitable for a particular application. Furthermore, the processes 122, 124 may be repeated until only approximately the target number of abstraction representation types 108a-n, one hundred in the present example embodiment, are output to the output matrix 112. A final resultant number of the abstract representations 108 may only be approximately known because the data may not perfectly fit an even multiple of desired abstract representations 108. For example, if there are 10,005 data points and one hundred output abstract representations are desired, then one additional value may be included when computing five data points, whereas each of the other one hundred abstract representations use only one hundred data points each in the computation thereof.

Depending on the quantity of data, a blur function may be used to support viewing of the output matrix/matrices 112 on a small screen by the human observer(s) 104. The blur function effectively compresses the output data visually to ensure it fits on a given screen. The screen area used to display the data is proportional to the volume of input data. Before any blurring/scaling, each output abstract representation may correspond to one chunk of the input data. However, if the input data exceeds the maximum human-readable display area, the data may be blurred to facilitate display of the complete abstracted dataset on the screen. This procedure averages together adjacent data to reduce same to a manageable set for visual interpretation by the human observer 104. The implementation of this blur function may be similar to a conventional blur function used with known image processing techniques. However, in this case each “pixel” is instead a large vectored object, i.e., the abstract representations 108. In order to process the abstract representations 108 in a manner similar to pixels, the blur function may use as an input the underlying parameters from which the abstract representations 108 were derived. The blur function may then average abstract representations 108 in first cells with the abstract representations 108 of adjacent cells.

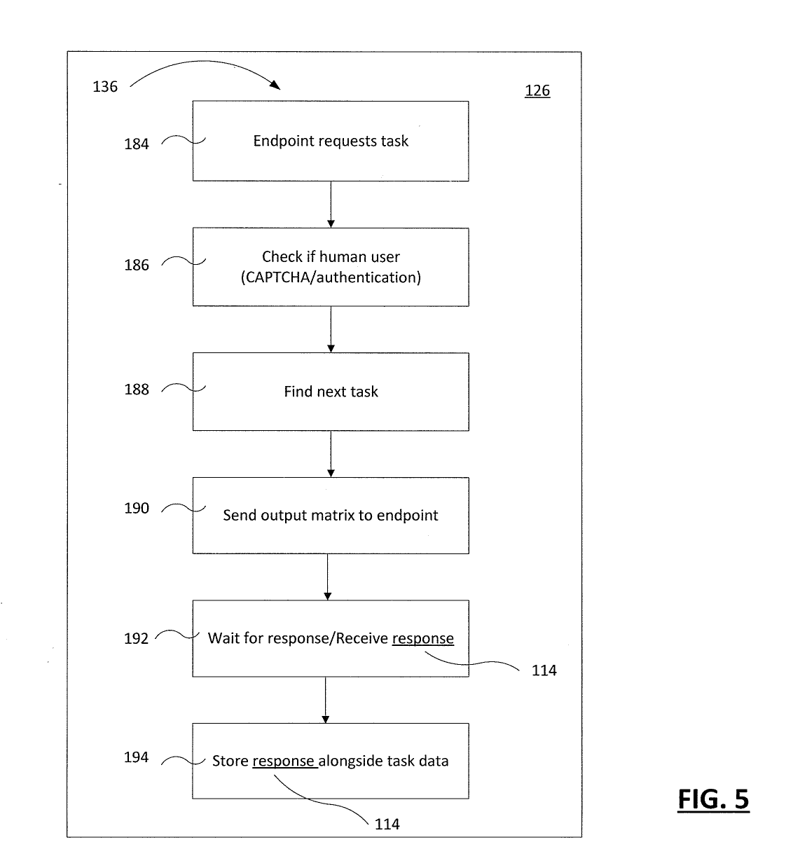

Alternatively, if the abstraction constraint step 180 indicates that fewer than the desired one hundred abstract representation types 108a-n have been produced for the visual representation 110 (i.e., output matrix 112), then the system 100 moves to step 182a. At the graphical representation production step 182a (see FIG. 4), the abstract representations 108 are stored as the output matrix 112 (see FIG. 1B). The output matrix 112 stored at this step 182a is ready for transmission to the human observer(s) 104 for observation, comparison, and classification according to steps depicted in FIG. 5. The output matrix 112, along with other output matrices, is stored on the cloud, on a server, or in some other suitable local or networked memory. The original subset of data from which the abstract representations 108 and visual representation 110 are developed may be retained, but same is not distributed to any of the human observer(s) 104.

Referring now to FIG. 5, the module 126 is illustrated as performing process 136 whereby pairs of the visual representations 110 are supplied to the human observer(s) 104 for comparison, pattern matching, and classification. At step 184, the human observer(s) 104 request a comparison task through the one or more endpoints 106 (see FIG. 1). In response to the request of step 184, at step 186 the system 100 confirms that the human observer(s) 104 are, in fact, human by employing a challenge-response test, such as a CAPTCHA, or another suitable authentication.

Once the one or more human observer(s) 104 are successfully authenticated, the system 100 determines a next available task, i.e., a next set of abstract representations for human comparison, at step 188 of process 136. The next set of available abstract representations may be randomly paired or chosen, or may be curated for training of human observers who are being introduced to the system 100. Specifically, when a new human observer first performs innate human pattern matching for the system 100, such user is tested by and acclimated to the system 100. The testing and acclimatization procedure involves presenting for observation a number of sets of visual representations 110 from known datasets and having similarly known classifications 114 therebetween. This human “training” set both allows the human observer(s) 104 to become familiar with the system 100 and appropriate responses, but also identifies and prevents abuse of the system 100 by provision of purposely inaccurate responses thereto. The classifications 114 produced by an individual human observer may be recorded, in association with identifying information for the individual human observer producing said classifications 114, so that accuracy, fraud, and abuse may be tracked and/or discerned.

Module 126 of FIG. 5 includes communications to one or more client devices 220, such as a computer or mobile device, and the endpoints 106 hosted thereon, for presentation of the visual representation(s) 110 to the one or more human observers 102. Further, the steps of process 136 may be performed within a user environment that connects the human observer(s) 104 with the system 100, such as Amazon's Mechanical Turk, Samasource, or another suitable intermediary for connecting humans with the visual representation(s) 110. At step 190, the next set of available abstract representations 108 is transmitted to the human observer(s) 104. The human observer(s) 104 then compares the abstract representations 108 at step 192. For example, the human observer(s) 104 compares two matrices abstractly representing drug and dosage information, as discussed hereinthroughout. The system 100 waits for the human observer(s) 104 to perform the comparison and then stores the classification 114, e.g., similar, not similar, somewhat similar, etc., returned by the human observer(s) 104 at step 194. Particular classification qualities may be customizable subject to the particular complex dataset 102 being evaluated, the type of abstract representation 108 being produced by the system 100, and the inputs needed to accurately train the target machine learning model 116 used by the system 100.

Each comparison may represent a single piece of data or a large group of data points depending on the subset of data forming the abstract representations 108 for the comparison. Each unique comparison pairing of visual representations 110 may be sent to one or more different human observers 104. If a comparison of two visual representations 110 is sent to multiple human observers 104, the classifications 114 produced by the multiple human observers 104 may be combined to produce an aggregate result. Developing an aggregate result may account for biases of individual human observers thereby producing an overall more reliable and consistent classification 114.

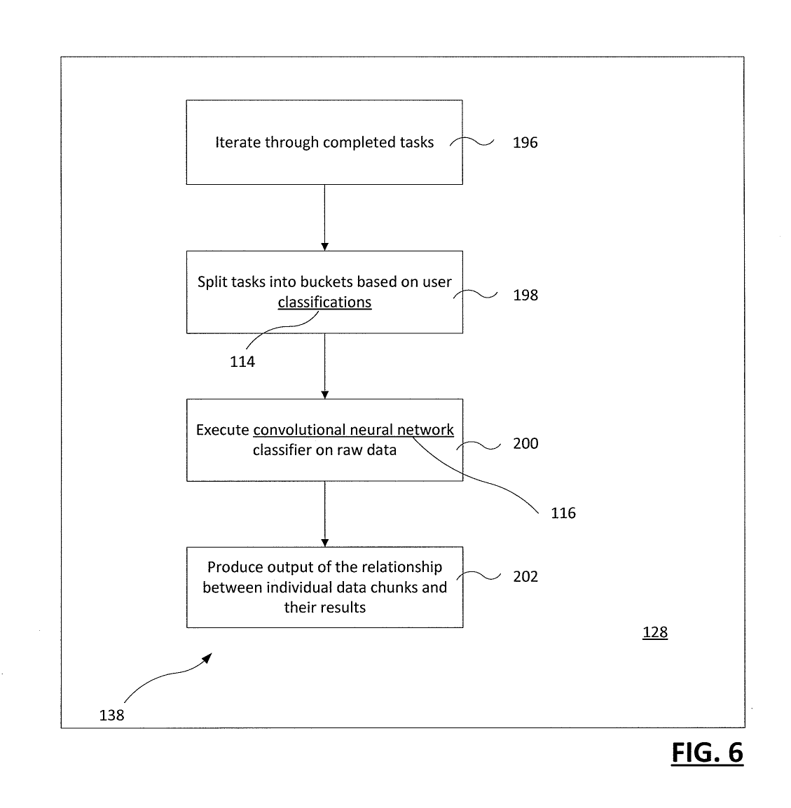

Referring now to FIG. 6, module 128 depicts process 138 wherein step 196 indicates repetition of process 136 of module 126 in FIG. 5, i.e., the step 196 indicates completion of multiple comparisons of visual representations 110. At step 198, the completed comparisons collected, in series or in parallel, in step 196 may be divided according to the classification(s) 114 provided by the one or more human observers 104. Separating the completed comparisons by similar classification 114 may provide more stable and efficient training of the one or more neural networks of the machine learning algorithms 116. Once a sufficient number of classifications 114 have been stored by module 126, machine learning algorithms 116 may apply the stored classifications 114 to the chunks 150a-n of data underlying production of the output matrices 112 (filled by abstract representations 108), identifying patterns within the complex dataset 102 based, in part, on where patterns emerge within the classifications 114 supplied by the human observer(s) 104. Results produced by the machine learning algorithms 116 are recursively directed back into the supervised machine learning algorithms 116 so as to iteratively tune the comparisons, thereby completing a feedback loop desirable for the training of the machine learning algorithms 116. The trained machine learning algorithms 116 may then apply machine learning-produced classifications of the sets of visual representations 110 previously classified by the human observer(s) 104.

Specifically, the machine learning algorithm(s) 116 may include a convolutional neural network. Convolutional neural networks apply a convolution operation on an input thereto. In this example embodiment, the classifications 114 of the abstract representation comparisons are back-propagated. This is in contrast with fully connected feedforward neural networks, which may require relatively large quantities of processing power and associated memory. Example embodiments contemplated by this disclosure utilize fully feed-forward, multi-layer neural networks. Example convolutional neural networks for use in conjunction with the disclosed system and method are Caffe, TensorFlow, and/or Theano. However, the system and method may operate with any training based classification network.

As shown in FIG. 6, step 200 executes the convolutional neural network classifier on the raw data of the complex dataset 102, and step 202 develops a relationship between individual chunks 150a-n and the various classifications 114 of which the individual chunks 150a-n are a component. The classifications developed by the machine learning algorithm(s) 116 may then be re-applied to subsequent complex datasets 102 and displayed to still further human observer(s) 104 for cross-validation and further refinement of the machine learning algorithm(s) 116. In this way, the machine learning algorithm(s) 116 are able to learn additional features and classify the underlying data accordingly.

The embodiment(s) detailed hereinabove may be combined in full or in part, with any alternative embodiment(s) described.

### INDUSTRIAL APPLICABILITY

Now with reference to the modules and processes 120-128, 130-138, respectively, an example embodiment of the system 100 is described as applied to an illustrative dataset. As an initial matter, the dataset 102 for which analysis is desired is built and identified. Such a process may take significant amounts of time and data gathering/entry; however, such a process may begin a significant amount of time, perhaps years, before the system 100 is employed to classify the unstructured data.

In an example application of the system 100, a medical researcher may be attempting to find which treatments are most effective for a particular type of patient. However, as noted previously, medical treatment records are complex and unstructured. Therefore, the medical researcher may have difficulty finding a pattern in the dataset 102 unaided. Furthermore, it is unlikely that a medical researcher will have the occupational bandwidth to expend numerous human-hours carefully reviewing thousands of patient charts. As an alternative to such a laborious task, the researcher may prepare the dataset, removing any personally identifiable patient information, and build a list of treatments for each patient. In some cases, the medical records may include many thousands of treatments over the course of numerous years of visits for each individual patient.

The system 100 may accept each of these individual patient databases and store same alongside a unique identifier, thereby keeping patient data separate, as necessary. The data for each patient is then abstracted into objects at process 120. In an example abstract representation 108, the shape of a graphical object correlates to a particular medicine and the color of said graphical object correlates to a particular dosage.

At process 126, these abstract representations 108 are transmitted, in an orderly and trackable manner, to a large pool of the human observers 104 located all across the globe and each using the endpoint application 106 for the system 100. Periodically, the human observer(s) 104 receive a notification of a new comparison task available for classification 114.

The human observer(s) 104 participate by opening newly available comparison tasks. The client device 220 of each human observer 104 will display two panels with graphical objects, abstract representations 108, of varying shapes and colors disposed on the first and second panels. The human observer(s) 104 subjectively identifies, overall, whether and how similar the visual representations 110 of the two panels appear. Each human observer 104 denotes the level of similarity between the visual representations 110 of the two panels by selecting a choice box. The choice box allows the human observer(s) 104 to select one of three relatively straightforward options: not similar, somewhat similar, and very similar. Of course, wording and specificity of the choice box selections may be varied, as applicable.

Next, the endpoint application 106 transmits the selection (of the human observer(s) 104) to the backend server 222. Then, the backend server 222 stores the classification 114 of the pairs of visual representations 110 alongside the source data for the particular patient.

In process 128, the classifications 114 produced by the human observer(s) 104 are then supplied to the machine learning algorithm 116, i.e., a standard convolutional neural network, which identifies meaningful relationships between the responses produced by the human observer(s) 104 and the portions of each treatment pattern most relevantly related within the illustrative dataset.

The above-described process may allow the medical researcher to identify that, for the patients in question, including a particular drug in the treatment regime thereof correlates with positive long-term health, and therefore the drug, should be considered for further research and practical testing. Thusly, the system has generalized long, complex sequences of medical treatments into abstracted visual representations 110 and used the human observer(s) 104 to compare same. The analysis provided by the system 100 may uncover subtle commonalities in treatment plans, which might otherwise be missed by conventional analysis.

Further example applications of the system include revealing anomalous transactions in credit card or banking transactions by generalizing normal transactions into abstract visual representations 108 and requesting comparison and classification 114 from the human observer(s) 104. Abnormal sequences may be identified visually and intuitively by using the system contemplated herein, whereas alternative fraud detection algorithms known in the art may otherwise require relatively cumbersome training.

Still further, the system may be used to classify unstructured social media data in the form of dictionary based lexicons, effectively outsourcing the task of identifying subtle meanings of sentiment, opinion, sarcasm, etc. Abstracting the sentiment as a graphical representation for human observers to classify in combination with a convolutional neural network, may develop greater subtlety and granularity between identified sentiments, e.g. satisfaction with a product or interest may be a more subtle sentiment than outright enthusiasm or loathing for same product or interest.

According to each of the illustrative examples described hereinabove, the machine learning models/algorithms 116 use the classification results 114 as a form of supervised learning. However, rather than requiring careful, expert-prepared data, the supervision may be provided by the inexperienced, untrained human observer(s) 104. Moreover, the interface through which the human observer(s) 104 interact with the system 100 may be implemented by and gamified by a smartphone application or free web service further encouraging classification, and thereby passive supervision, by the human observer(s) 104.

The system of the present disclosure presents advantages over a traditional image recognition tool or text-based machine learning application. Instead, the system advantageously identifies patterns across a broader set of data, often complex data. Each individual contributing piece of data may be relatively simple to compare, save for spelling and grammatical mistakes therein. For example, as discussed hereinabove, differences in dosages (e.g. “500 mg ibuprofen” as compared with “250 mg ibuprofen”) may be relatively straightforward to compare in isolation. However, the system is directed towards developing comparisons across relatively larger subsets of data.

The present disclosure details numerous example subsystems and subcomponents involved in deriving meaning from complex datasets such as social media data. One objective of the system 100 is to receive as an input the social media profile and posted messages of a user and produce a detailed analysis of that user. The detailed analysis may include interests, preferences, attributes (e.g. age, gender, salary, location), and overall affinity categorizations of the user. Moreover, the detailed analysis may produce useful information, including that previously mentioned, for audience segmentation and marketing purposes.

The system 100 includes the network 206 or other communication mechanism for communicating information, and a processor in one or more of the client(s) 220 and/or server(s) 222. According to one aspect, the system 100 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the system 100 may include one or more processor(s) such as a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

The system 100 may include, in addition to hardware, code that creates an execution environment for the computer program in question, e.g., code that constitutes processor firmware, a protocol stack, a database management system, an operating system, or a combination of one or more of them stored in an included memory, such as a Random Access Memory (RAM), a flash memory, a Read Only Memory (ROM), a Programmable Read-Only Memory (PROM), an Erasable PROM (EPROM), registers, a hard disk, a removable disk, a magnetic disk, an optical disk, a CD-ROM, a DVD, or any other suitable storage device, coupled to the server(s) 222 and the network 206 for storing information and instructions to be executed by the one or more processor(s). The processor(s) and the memory may be supplemented by, or incorporated in, special purpose logic circuitry. Expansion memory may also be provided and connected to the system 100 through one or more of the server(s) 222 and client(s) 220, which may include, for example, a SIMM (Single In Line Memory Module) card interface. Such expansion memory may provide extra storage space for system 100 or may also store applications or other information. Specifically, expansion memory may include instructions to carry out or supplement the processes described above and may further store secure information. Thus, for example, expansion memory may be provided as a security module for the system 100 and may be programmed with instructions that permit secure use of the system 100. In addition, secure applications may be provided via the SIMM cards, along with additional information, such as placing identifying information on the SIMM card in a non-hackable manner.

The instructions may be stored in memory and implemented in one or more computer program products, i.e., one or more modules of computer program instructions encoded on a computer readable medium for execution by, or to control the operation of, the system 100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory may also be used for storing temporary variable or other intermediate information during execution of instructions.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by the communication network 206. The processes and logic flows described in this specification can be performed by one or more programmable processors executing one or more computer programs to perform functions by operating on input data and generating output.

The components of the system can be interconnected by any form or medium of digital data communication, e.g., a communication network. The communication network (e.g., network 206) can include, for example, any one or more of a PAN, a LAN, a CAN, a MAN, a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like.

For example, in certain aspects, the system 100 may be in two-way data communication via a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, client(s) 220 and server(s) 222 send and receive electrical, electromagnetic or optical signals that carry digital data streams representing various types of information. The network link typically provides data communication through one or more networks to other data devices. For example, the network 206 may provide a connection through local network to a host computer or to data equipment operated by an Internet Service Provider (ISP). The ISP in turn provides data communication services through the worldwide packet data communication network now commonly referred to as the Internet. The local network and Internet both use electrical, electromagnetic or optical signals that carry digital data streams. The signals propagated through the various components of the network 206, which carry the digital data betwixt and between elements of the system 100, are example forms of transmission media. In the Internet example, the one or more server(s) 222 might transmit a requested code for an application program through the Internet, the ISP, the local network the components of the system 100.

In certain aspects, the server(s) 222 and/or client(s) 220 are configured to connect to a plurality of devices, such as an input device 208 (e.g., keyboard) and/or the output device/display 210 (e.g., touch screen). For example, the input device 208 may include a stylus, a finger, a keyboard and a pointing device, e.g., a mouse or a trackball, by which a user can provide input to the system 100. The client(s) 220 may include input devices used to provide for interaction with the human observer(s) 104, such as a tactile input device, visual input device, audio input device, or brain-computer interface device. For example, the abstract representations 108 provided to the human observer(s) 104 may be any form of sensory feedback, e.g., visual feedback, auditory feedback, or tactile feedback; and input from the user can be received in any form, including acoustic, speech, tactile, or brain wave input. Example output devices 210 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the human observer(s) 104. The output devices/displays 210 may comprise appropriate circuitry for driving the client device(s) 220 to present graphical and other information to the human observer(s) 104.

According to one aspect of the present disclosure, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components.

As discussed hereinabove, the system may include clients and servers. A client and server are generally remote from each other and typically interact through a communication network. The relationship of client and server arises by virtue of computer programs running on the respective computers and having a client-server relationship to each other. The system may include, for example, and without limitation, a desktop computer, laptop computer, or tablet computer. The system may also be, in whole or in part, embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processors of the system for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as might be utilized by the client(s) and/or server(s). Volatile media include dynamic memory may also be used. Transmission media include coaxial cables, copper wire, and fiber optics, including the wires that comprise portions of the network. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read/be instructed. The machine-readable storage medium can be a machine-readable storage device, a machine-readable storage substrate, a memory device, a composition of matter affecting a machine-readable propagated signal, or a combination of one or more of them.

As used in the specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

Headings and subheadings, if any, are used for convenience only and do not limit the disclosure. The word exemplary is used to mean serving as an example or illustration.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such terms are intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Relational terms such as first and second and the like may be used to distinguish one entity or action from another without necessarily requiring or implying any actual such relationship or order between such entities or actions. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

The disclosed systems and methods are well adapted to attain the ends and advantages mentioned as well as those that are inherent therein. The particular implementations disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure. Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

What is claimed is:

1. A system for analyzing complex datasets, comprising:
one or more servers;
one or more machine learning algorithms;
one or more client devices;
one or more displays associated with the one or more client devices;
a network connecting the one or more servers and the one or more client devices; and
wherein a complex dataset is stored on the one or more servers;
wherein the complex dataset is processed by the one or more servers;
wherein the complex dataset is parsed into one or more chunks and the one or more chunks are abstracted as a plurality of abstract representations;
a plurality of graphical matrices comprising the plurality of abstract representations;
wherein the one or more servers transmit, over the network to the one or more client devices, at least first and second graphical matrices of the plurality of graphical matrices developed from the complex dataset for display to a human observer;
wherein the human observer compares the first and second graphical matrices;
wherein the human observer classifies the graphical matrices and said classification provides the one or more machine learning algorithms with information about the complex dataset.

2. The system of claim 1, wherein the classification by the human observer is one of similar, dissimilar, and somewhat similar.

3. The system of claim 2, wherein pairs of graphical matrices are presented to a plurality of human observers; and wherein the classifications of the plurality of human observers are combined to develop an aggregate classification.

4. The system of claim 3, wherein the aggregate classification is provided as an input to the one or more machine learning algorithms; and wherein the one or more machine learning algorithms include a convolutional neural network.

5. The system of claim 1, wherein one or more abstraction functions operate to abstract the one or more chunks as abstract representations; and wherein the abstraction function used to abstract the one or more chunks is at least partially determined by a type of data comprising the complex dataset.

6. The system of claim 1, wherein one or more of the abstract representations are combined to produce the graphical matrices.

7. The system of claim 1, wherein the one or more chunks are compared to one another according to a similarity threshold; and wherein the abstract representations are produced for the one or more chunks that are below the similarity threshold.

8. The system of claim 1, wherein a blur function is applied to the graphical matrices before presentation to the human observers.

9. The system of claim 1, wherein the classification provided by the human observer is communicated to the one or more machine learning algorithms to train the one or more machine learning algorithms.

10. A method of analyzing complex datasets, comprising:
parsing a complex dataset into one or more chunks;
interpreting each chunk as one or more respective abstract representations;
presenting the one or more abstract representations to one or more human observers as one or more visual representations;
wherein the one or more human observers are presented with first and second visual representations of the one or more abstract representations; and
wherein the one or more human observers compares the first and second visual representations to produce one or more respective classifications;
receiving the one or more classifications of the respective one or more visual representations;
providing the one or more classifications to a machine learning algorithm; and
analyzing the complex dataset in view of the one or more classifications.

11. The method of claim 10, further comprising:
presenting one or more test visual representations comprised of the one or more abstract representations to the one or more human observers before presenting the one or more visual representations to the one or more human observers, wherein the test visual representations have one or more known classifications.

12. The method of claim 10, wherein the one or more human observers classifies the first and second visual representations as one of similar, dissimilar, and somewhat similar.

13. The method of claim 10, further comprising:
presenting the first and second visual representations to a plurality of human observers;
receiving a plurality of classifications of the first and second visual representations; and
aggregating the plurality of classifications of the first and second visual representations.

14. The method of claim 13, wherein the machine learning algorithm is a convolutional neural network.

15. The method of claim 10, further comprising:
determining a threshold similarity correlated with a number of abstract representations to include in each visual representation;
comparing the one or more chunks of data to one another before interpreting each chunk as the respective one or more abstract representations;
identifying whether the one or more chunks are above the threshold similarity; and
iteratively comparing the one or more chunks of data to one another until all chunks included in the visual representation are above the similarity threshold.

16. The method of claim 10, wherein each visual representation is a matrix; and wherein each abstract representation is an entry in the matrix.

17. The method of claim 16, wherein a blur function is applied to each matrix before the one or more visual representations are presented to the one or more human observers.

18. A system for training neural networks, comprising:
a server connected to a network;
a plurality of client devices connected to the network;
at least one neural network algorithm executed by a processor and memory of the server;
a complex dataset available to the server for analysis;
wherein the system separates the complex dataset into chunks;
an abstraction function wherein the chunks of the complex dataset are interpreted as abstract representations;
wherein the abstract representations are displayed to human observers by the plurality of client devices;
wherein the human observers recognize patterns among the abstract representations; and
wherein a result of the pattern recognition of the human observers is applied to the training of the at least one neural network algorithm.

19. The system for training neural networks of claim 18, wherein the abstract representations are arranged in one or more graphical matrices for display to the human observers.

20. The system for training neural networks of claim 18, wherein the result of the human pattern recognition is applied to the data underlying the abstract representations displayed to the human observers by the at least one neural network algorithm to further train the at least one neural network algorithm.
